(19) United States
(12) Patent Application Publication
(10) Pub. No.: US 2009/0049167 A1
(43) Pub. Date: Feb. 19, 2009

(54) PORT MONITORING

(76) Inventor: David N. Fox, Firestone, CO (US)

Correspondence Address: HOFFMAN WARNICK LLC, 75 STATE ST, 14TH FLOOR, ALBANY, NY, 12207, US

(21) Appl. No.: 11/839,643

(22) Filed: Aug. 16, 2007

(51) Int. Cl. G06F 15/173

(52) U.S. Cl. 709/224; 370/241

(57) ABSTRACT

The invention is directed to the transparent allocation of a unique per user /tmp file system. A method for monitoring a port in accordance with an embodiment of the present invention includes: obtaining a current uptime of a network switch; obtaining a status of a port of the network switch; in the case that the port of the network switch is idle: comparing the uptime of the network switch to a last used time of the port; and determining that the network switch has been rebooted since the port was last used, in the case that the uptime of the network switch is less than the last used time of the port.

### BACKGROUND OF THE INVENTION

1. Field of the Invention

The present invention generally relates to network systems. More specifically, the present invention is directed to the monitoring of ports in a network.

2. Related Art

One concern in managing a local area network is tracking port usage and availability. When a network switch is rebooted, timers on the switch are reset. This can lead to false positives indicating that ports on the switch have recently been used.

### SUMMARY OF THE INVENTION

The present invention is directed to the monitoring of ports in a network.

An aspect of the invention is directed to a method for monitoring a port, comprising: obtaining a current uptime of a network switch; obtaining a status of a port of the network switch; in the case that the port of the network switch is idle: comparing the uptime of the network switch to a last used time of the port; and determining that the network switch has been rebooted since the port was last used, in the case that the uptime of the network switch is less than the last used time of the port.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative process for monitoring ports in accordance with embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As described above, the present invention is directed to the monitoring of ports in a network.

Simple Network Management Protocol (SNMP) timers for Up Time and Port Last Change times are based on how many time intervals (e.g., 100 milliseconds) have passed since a network switch was rebooted in some manner (e.g., reboot, reset, etc.). As alluded to above, simply looking at the Port Last Change time could lead to false positives indicating that the ports of the switch have been recently used. The present invention tracks port usage and availability across switch reboots.

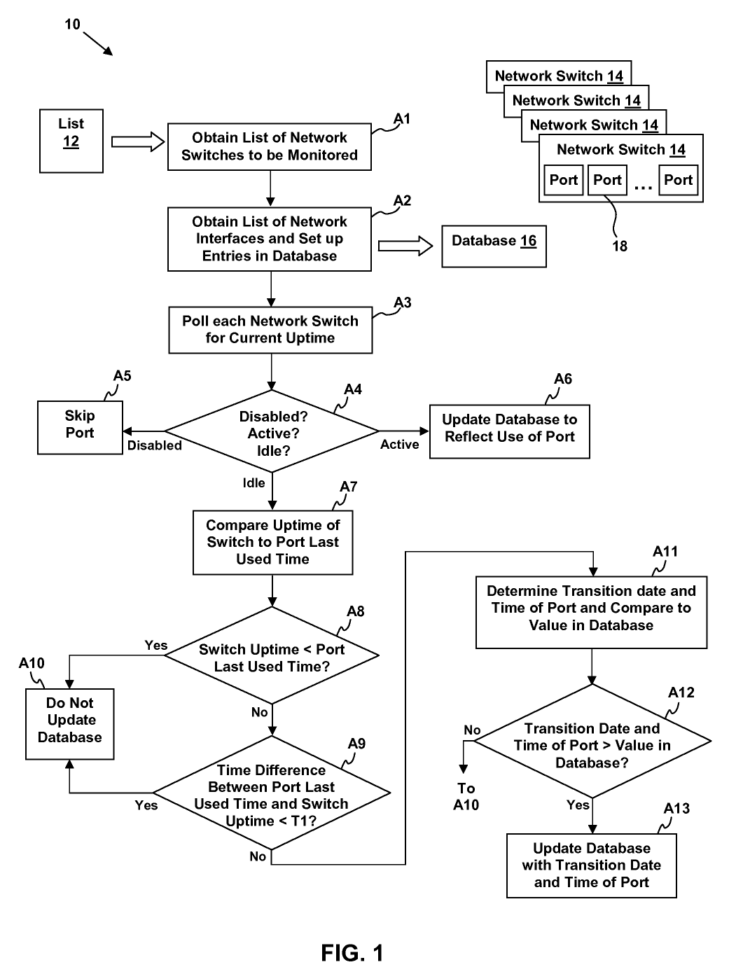

FIG. 1 depicts an illustrative process 10 for monitoring ports in accordance with embodiment(s) of the present invention.

In A1, a list 12 of network switches 14 to be monitored is obtained. In A2, a list of network interfaces associated with the switches 14 is obtained via SNMP, and an entry is set up for each interface in a database 16.

Periodically, in A3, each switch 14 is polled for its current uptime (i.e., how long the switch has been running). This can occur, for example, from once an hour to once a day, etc. Other time periods are also possible, and the illustrative time periods are not meant to be limiting in any way. Further, for each port 18 of the switch 14 that is enabled, the following information is collected:
1. The current administrative status (i.e., is the port enabled).
2. The current operational status (i.e., is the port currently active).
3. The last transition time (i.e., when the port last changed state: up to down, down to up).

If a port 18 has been disabled (Disabled, A4), for example, by a network administrator, that port 18 is skipped in A5. If the port 18 is active (Active, A4), the database 16 is updated in A6 to reflect that the port 18 has been used. This is done by setting a Port Last Used time of the port 18 to the current time in the database 16.

If the port 18 is currently idle (Idle, A4), flow passes to A7. In A7, the Port Last Used time for the port 18 is retrieved from the database 16 and is compared to the uptime of the switch 14.

In A8, if the uptime of the switch 14 is less than the Port Last Used time (Yes, A8), then this indicates that the switch 14 has been rebooted since the port 18 was last used. As a result, flow passes to A10 and the database 16 is not updated.

If it is determined in A8 that the uptime of the switch 14 is greater than the Port Last Used time (No, A8), then this indicates that the port 18 has been used since the last reboot of the switch 14. Flow then passes to A9, where the Port Last Used time of the port 18 is compared to the uptime of the switch 14 in greater detail.

In A9, if the time difference between the Port Last Used time of the port 18 and the uptime of the switch 14 is less than an administratively determined threshold T1 (e.g., five minutes) (Yes, A9), then this indicates that the port 18 has not been used since the last reboot of the switch 14 (there can be a lag of several minutes after reboot of the switch 14 before the port 18 becomes active). This lag time can be used, for example, by an administrator, to set the threshold T1. In this case, flow then passes to A10 and the database 16 is not updated.

If it is determined in A9 that the time difference between the Port Last Used time of the port 18 and the uptime of the switch 14 is greater than the predetermined threshold T1 (No, A9), then in A11 the transition date and time of the port 18 is determined and compared to the value in the database 16.

In A12, if the transition date and time of the port 18 is determined to be greater than the value in the database 16 (Yes, A12), within a threshold T2, then this indicates that the port 18 has been used since last checked. The threshold T2 can be set, for example, by an administrator or in any suitable manner. In this case, the database 16 is updated in A13 with the transition date and time of the port 18 determined in A11. If, however, the transition date and time of the port 18 is determined to be less than the value in the database 16 (No, A12), within the threshold T2, then this indicates that the port 18 has not been used since last checked. In this case, flow then passes to A10 and the database 16 is not updated.

It should be noted that (A1) to (A13) are intended to represent method steps, system components, and/or program code configured to implement the present invention.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

The foregoing description of the embodiments of this invention has been presented for purposes of illustration and description. It is not intended to be exhaustive or to limit the invention to the precise form disclosed, and many modifications and variations are possible.

What is claimed is:

1. A method for monitoring a port, comprising:
obtaining a current uptime of a network switch;
obtaining a status of a port of the network switch;
in the case that the port of the network switch is idle:
comparing the uptime of the network switch to a last used time of the port; and
determining that the network switch has been rebooted since the port was last used, in the case that the uptime of the network switch is less than the last used time of the port.

2. The method of claim 1, further comprising:
determining a time difference between the last used time of the port and the uptime of the network switch time, in the case that the uptime of the network switch is greater than the last used time of the port;
comparing the time difference to a threshold; and
obtaining a transition date and time of the port and comparing the transition date and time of the port to a value in a database, in the case that the time difference is greater than the threshold.

3. The method of claim 2, further comprising:
updating the database with the transition date and time of the port, in the case that the transition date and time is greater that the value in a database.

4. The method of claim 3, further comprising:
not updating the database with the transition date and time of the port, in the case that the transition date and time is less that the value in a database.

5. The method of claim 1, further comprising:
skipping the port, in the case that the port is disabled.

6. The method of claim 1, further comprising:
updating a database to reflect use of the port, in the case that the port is active.
